(19) United States
(12) Patent Application Publication
(10) Pub. No.: US 2007/0223229 A1
(43) Pub. Date: Sep. 27, 2007

(54) Luminaire and Lamellae Louver Therefor

(75) Inventor: Paulus Gerardus Henricus Kosters, Winterswijk (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,635

(22) PCT Filed: May 3, 2005
(86) PCT No.: PCT/IB05/51447

§ 371 Date: Nov. 3, 2006

(30) Foreign Application Priority Data
May 7, 2004 (EP) 04101981.1

(51) Int. Cl. F21V 11/02

(52) U.S. Cl. 362/291

(57) ABSTRACT

The luminaire has concave side reflectors (2) defining the width W of a light emission window (1). A plurality of lamellae (10) is present between the side reflectors (2), which have a central height h0 which is <0.15 W. The lamellae (10) are mounted close to means (4) for accommodating an electric lamp Ls and have a special shape. As a result of their shape, size and position the lamellae (10) have a relatively low material content. The lamellae louver (20) is suitable for use in the luminaire.

The invention relates to a luminaire provided with:

a light emission window of a width W;

elongate side reflectors, placed opposite each other, equidistant from a plane P that is perpendicular to the light emission window, which side reflectors have an edge defining the width W of the light emission window and are concavely curved cross to the edge, inclining to one another away from the light emission window;

means for accommodating an elongate electric lamp Ls between the side reflectors, along the light emission window and in plane P; and

a plurality of substantially parallel, substantially equidistant lamellae transverse to plane P and transverse to the light emission window,

which lamellae have an outer edge which is remote from the means and an inner edge remote from the light emission window, the outer edge having a concave shape and in plane P a distance h0 to the inner edge which is related to the width W.

The invention also relates to a lamellae louver comprising a plurality of substantially parallel, substantially equidistant, interconnected plastic lamellae having an outer edge which has a concave shape, and an opposed inner edge.

An embodiment of such a luminaire, as well as of such a louver, is known from WO 2004/013537 A1.

The side reflectors collect the light generated by an operating accommodated electric lamp Ls into a beam and create a shielding angle aside the luminaire within which the lamp is not visible. The e.g. strip shaped lamellae have a shielding function in plane P and in planes surrounding plane P to avoid that the lamp can be seen from within the shielding angle.

In the known luminaire the lamellae have a triangular cross-section, the basis of which is inside the luminaire. The flanks of the lamellae may be flat or concave. Such lamellae are required in case the luminaire is intended for use in rooms in which computer terminals are present. Light rays which are reflected by the lamellae are as a result of the triangular cross-section reflected at a larger angle to the light emission window than corresponding light rays by flat lamellae. It is thereby avoided that in plane P and in surrounding planes light rays are reflected within the shielding angle and cause annoying reflections on screens of terminals.

As it appears from the document cited, it is another function of the lamellae to prevent that images of the lamp formed in the side reflectors can be observed within the shielding angle. In order to achieve this, lamellae generally are relatively extended and voluminous, having to their effect that additional reflections occur in the luminaire which cause loss of light due to absorption at each reflection.

According to the document cited, lamellae are used that have a small central height h0 related to the width W of the light emission window. As a result, in order to achieve proper shielding in and around plane P a relatively large number of lamellae is required. The outer edge of the lamellae has a concave curvature throughout its length, whereas the inner edge generally is straight and parallel to the light emission window.

It is a disadvantage of the known luminaire that the total material content of the lamellae is relatively high due to their number, shape and size. This increases the cost price of the luminaire.

It is a first object of the invention to provide a luminaire of the kind described in the opening paragraph the lamellae of which have a relatively low material content.

It is another object of the invention to provide a lamellae louver of the kind described in the opening paragraph which has a relatively low material content

The first object is achieved in that the luminaire has the features of claim 1.

The central portion of the lamellae mainly has the function to screen a lamp Ls accommodated by the means from being visible from inside the shielding angle. The end portions prevent light rays reflected by the side reflectors to emanate inside the shielding angle. The intermediate portions predominantly have the function to keep the other portions positioned by interconnecting them and to intercept light rays which would otherwise, either directly from the lamp or after reflection by the side reflectors, emanate within the shielding angle.

The lamellae are preferably positioned deep in the luminaire, but at a distance of a few mm, e.g. 5 mm, from the lamp in order to avoid that the lamp, when operating, adjacent the lamellae has a relatively low temperature. A suitable lamp is an elongate tubular fluorescent lamp. Because the lamellae are remote from the light emission window and because the side reflectors are inclining to one another, the lamellae have a length which is smaller than the width of the light emission window. As a result thereof and of their shape, particularly their inwardly sloping outer edges in the end portions, the lamellae have a relatively small material content and also cause a relatively small loss of light by absorption.

The outer edge in the intermediate portions preferably forms the shortest connection between the outer edge in the central and in the end portions.

It is furthermore an advantage of the luminaire of the invention, that the lamellae may have a high gloss finish, also when the side reflectors are mat or semi-specularly reflecting, without substantially influencing the appearance of the luminaire. This provides for a large flexibility in designing the luminaire.

The inner edge of the lamellae may be straight, substantially parallel to the light emission window. It is favorable, however, if the luminaire has the feature of claim 2. The lamellae then have at an equal height h0 a particular small material content.

For the same reason and for counteracting the occurrence of undue reflections it is favorable if the luminaire has the feature of claim 3.

The inner edge in the intermediate portions may form the shortest connection between the inner edge in the central and in the end portions. It is particularly favorable, if the luminaire has also the feature of claim 4.

The lamellae may be metal, e.g. aluminum, specular or semi-specular, or plastic plates. The plastic may be e.g. colored, opaque or translucent. Translucent lamellae also have a decorative function apart from the lamp shielding function. Plate shaped lamellae, unless profiled e.g. by the presence of undulations or ribs in their length direction, have no beam shaping effect.

In a special embodiment the lamellae have a V-shaped cross-section and h0 is <0.07 W, for example within the range of 0.06 to 0.07. This is particularly favorable for reflecting incident light into a larger angle to the light emission window and thereby into the beam formed by the luminaire, and for a low material content. In general h0 is greater than 0.03 W, because it favors the form-retaining properties of the lamellae.

In this favorable embodiment the lamellae are favorably of plastic, have a specularly or semi-specularly mirroring coating and have a structured surface between the inner edges. Such a structured surface between inner edges of V-shaped lamellae is well known in the art to prevent light rays after reflection to the side reflectors to be reflected into the shielding angle. The structure of the surface may, for example, consist of regions having a smaller angle to plane P than the inner edge portions by which these regions are bounded. The surface could otherwise be diffusely reflecting by being roughened.

The lamellae may be connected inseparably to the side reflectors. In an embodiment, however, the luminaire has the feature of claim 6. A louver of plastic is easy to manufacture and has the advantage that a lot of assembling work is avoided, which must be done in case the lamellae are separate bodies. The louver may e.g. have a click connection to the side reflectors. Alternatively, the louver may be connected to end faces of the luminaire.

The second object of the invention is achieved in that the lamellae have:

a central portion in which the outer edge has the concave shape and touches with ends thereof a plane Q;

end portions in which the outer edge has an increasing distance to plane Q the closer approaching an end of the lamella; and

intermediate portions connecting the central portion to the end portions.

What has been explained above with respect to the luminaire according to the invention similarly applies to the lamellae louver.

The lamellae and the lamellae louver may be formed, for example, from polycarbonate (PC), polysterene (PS), polycarbonate.arylonitrilbutadienestyrene (PC.ABS).

The side reflectors may be united to form a reflector body which is also present opposite the light emission window. The luminaire may also or alternatively be present in a housing. An e.g. lacquered wall opposite the light emission window constituting a reflector. The luminaire may, however, have a second window opposite the light emission window in order also to provide indirect lighting.

The luminaire may, mounted against, in or below a ceiling, be used for illuminating e.g. offices and shops.

An embodiment of the luminaire and of the lamellae louver according to the invention is shown in and explained with reference to the drawings.

In the drawings:

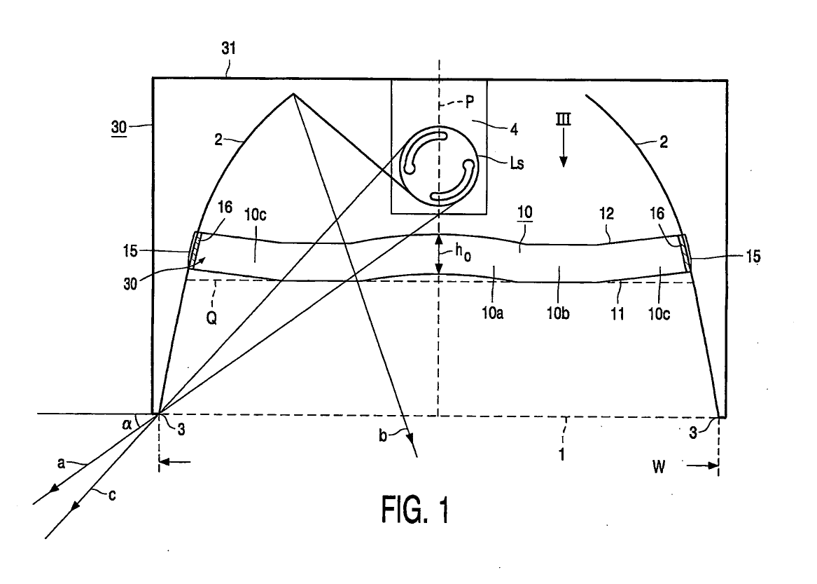

FIG. 1 represents a cross section through a first embodiment;

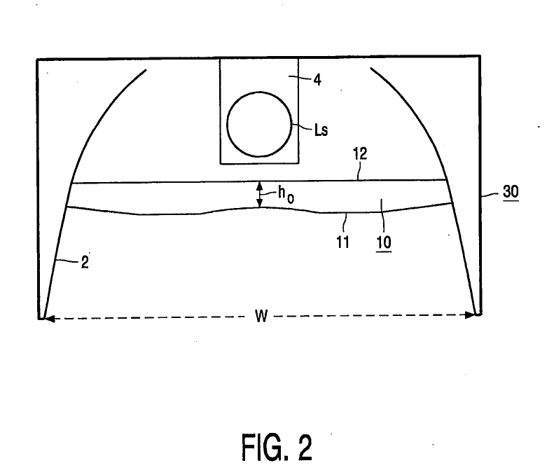

FIG. 2 a cross section through a second embodiment;

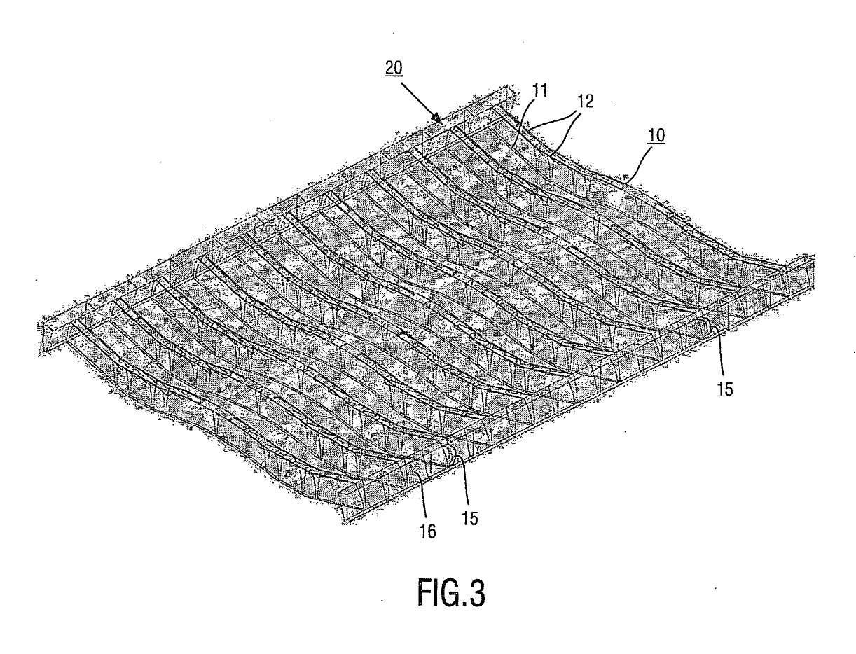

FIG. 3 a perspective view of the lamellae louver of FIG. 1, seen from inside the luminaire.

In FIG. 1 the luminaire has a light emission window 1 of a width W. Elongate side reflectors 2 are placed opposite each other, equidistant from a plane P that is perpendicular to the light emission window. The side reflectors 2 have an edge 3 which define the width W of the light emission window 1. They are concavely curved cross to the edge 3 and incline to one another away from the light emission window 1.

Means 4 are present for accommodating an elongate electric lamp Ls between the side reflectors 2, along the light emission window 1 and in plane P.

The luminaire, compare FIG. 3, has a plurality of substantially parallel, substantially equidistant lamellae 10 transverse to plane P and to the light emission window 1.

The lamellae 10 have an outer edge 11 which is remote from the means 4 and an inner edge 12 remote from the light emission window 1. The outer edge 11 has a concave shape and in plane P a distance h0 to the inner edge 12 which is related to the width W.

According to the invention, the lamellae 10 have a central portion 10a through plane P in which the outer edge 11 has the concave shape and touches with ends thereof a plane Q which is substantially parallel to the light emission window 1. They furthermore have end portions 10c adjacent the side reflectors 2 in which the outer edge 11 has an increasing distance to plane Q the closer approaching the respective side reflector 2, and intermediate portions 10b connecting the central portion 10a to the end portions 10c. The height of the lamellae h0, the distance between the inner edge 10 and the outer edge 11 in plane P, is <0.15 W. The lamellae 10 are remote from the light emission window 1.

In the luminaire of FIG. 1 the lamellae 10 are about as deep in the luminaire as is possible, at a distance from a mounted lamp Ls of about 5 mm. The lamp Ls is a low-pressure mercury fluorescent lamp.

It is seen that in FIG. 1 the central portion 10a of the lamella 10 extends just beyond the area through which, in case a reflector opposite the light emission window 1 is absent, almost only light rays pass without prior reflection by the side reflectors 2. An ultimate light ray a) is shown, which can, in the plane of the drawing, directly emanate and which illustrates the shielding angle α. Another ultimate light ray b) is reflected by the side reflector 2 at the very top thereof. It crosses the lamella 10 at about the same point as light ray a). A third ultimate light ray c) in the plane of the drawing leaves the luminaire without prior reflection steeper with respect to the light emission window than ray a). In the Fig. it marks about the beginning of the end portion 10c of the lamella 10, which is substantially passed by reflected rays only. The intermediate portion 10b is passed by light rays directly originating from the lamp and by light rays which are reflected by the side reflectors 2.

In FIG. 1 the outer edge 11 makes an angle of several degrees to the light emission window 1, i.e. 70.

In the central portion 10a of the lamellae 10 the inner edge 12 has a convex curvature.

In the end portions 10c of the lamellae 10 the inner edge 12 has an increasing distance to plane Q the closer approaching the respective side reflector 2.

In FIG. 1, the outer 11 and the inner 12 edges are predominantly substantially parallel. In this Figure the lamellae have about the same height in the central 10a and in the end portions 10c.

The lamellae 10 have a V-shaped cross-section and h0 is <0.07 W, in the Fig. 0.065.

The lamellae 10 are of plastic, i.e. polycarbonate, have a mirroring coating and a structured surface between the inner edges 12.

The lamellae 10 are united to constitute a louver 20 which is releasably connected to the side reflectors 2. The lamellae are interconnected by means of strips 16 which rest against the side reflectors 2. Ridges 15 are present at some of the lamellae 10, which snapped into recesses in the side reflectors 2 to constitute a snap connection. The lamellae 10 contain about 30% material less than the lamellae of the known luminaire.

The luminaire has a housing 30, the top wall 31 of which is at its inner surface lacquered white.

In FIG. 2 the reference numerals have the same meaning as in FIG. 1. The lamella 10 shown in FIG. 2 has a straight inner edge 12. At an equal width W and an equal height h0 the lamella of this Fig. has a larger material content than the one of FIG. 1.

In FIG. 3 the lamellae louver 20 comprises a plurality of substantially parallel, substantially equidistant, interconnected lamellae 10. The lamellae 10 having an outer edge 11 which has a concave shape, and an inner edge 12.

The lamellae 10 have a central portion 10a in which the outer edge 11 has the concave shape and touches with ends thereof a plane Q, end portions 10c in which the outer edge 11 has an increasing distance to plane Q the closer approaching an end of the lamella 10, and intermediate portions 10b connecting the central portion 10a to the end portions 10c.

1. A luminaire provided with:
a light emission window (1) of a width W;
elongate side reflectors (2), placed opposite each other, equidistant from a plane P that is perpendicular to the light emission window, which side reflectors (2) each have an edge (3) defining the width W of the light emission window (2) and are concavely curved transversely to the edge (3), inclining towards one another away from the light emission window (1);
means (4) for accommodating an elongate electric lamp Ls between the side reflectors (2), along the light emission window (1) and in plane P; and
a plurality of substantially parallel, substantially equidistant lamellae (10) transverse to plane P and to the light emission window (1),
which lamellae (10) each have an outer edge (11) which is remote from said means (4) and an inner edge (12) remote from the light emission window (1), the outer edge (11) having a concave shape and in plane P a distance h0 to the inner edge (12) which is related to the width W,
characterized in that the lamellae (10) have:
a central portion (10a) through plane P in which the outer edge (11) has the concave shape and is tangent with ends thereof to a plane Q which is substantially parallel to the light emission window (1);
end portions (10c) adjacent the side reflectors (2) in which the outer edge (11) has an increasing distance to plane Q the closer it approaches the respective side reflector (2); and
intermediate portions (10b) connecting the central portion (10a) to the end portions (10c),
h0 being <0.15 W, and the lamellae (10) being remote from the light emission window (1).

2. A luminaire as claimed in claim 1, characterized in that in the central portion (10a) of the lamellae (10) the inner edge (12) has a convex curvature.

3. A luminaire as claimed in claim 2, characterized in that, in the end portions (10c) of the lamellae (10), the inner edge (12) has an increasing distance to plane Q the closer it approaches the respective side reflector (2).

4. A luminaire as claimed in claim 3, characterized in that the outer (11) and the inner (12) edges are predominantly substantially parallel.

5. A luminaire as claimed in claim 1, characterized in that the lamellae (10) have a V-shaped cross-section and h0 is <0.07 W.

6. A luminaire as claimed in claim 5, characterized in that the lamellae (10) are of plastic and have a mirroring coating and a structured surface between the inner edges (12).

7. A luminaire as claimed in claim 5, characterized in that the lamellae (10) are united to constitute a louver (20) which is detachably connected to the side reflectors (2).

8. A lamellae louver (20) comprising a plurality of substantially parallel, substantially equidistant, interconnected lamellae (10) each having an outer edge (11) which has a concave shape and an inner edge (12),
characterized in that the lamellae (10) have:
a central portion (10a) in which the outer edge (11) has the concave shape and is tangent with ends thereof to a plane Q;
end portions (10c) in which the outer edge (11) has an increasing distance to plane Q the closer it approaches an end of the lamella (10); and
intermediate portions (10b) connecting the central portion (10a) to the end portions (10c), for use in the luminaire of claim 1.
